(19) United States
(12) Patent Application Publication
(10) Pub. No.: US 2021/0318714 A1
(43) Pub. Date: Oct. 14, 2021

(54) Optical Signal Processing Device

(71) Applicant: Nippon Telegraph and Telephone Corporation, Tokyo (JP)

(72) Inventors: Shiori Konisho, Musashino-shi, Tokyo (JP); Toshikazu Hashimoto, Musashino-shi, Tokyo (JP); Mitsumasa Nakajima, Musashino-shi, Tokyo (JP)

(21) Appl. No.: 17/268,187

(22) PCT Filed: Aug. 14, 2019
(86) PCT No.: PCT/JP2019/031972

§ 371 Date: Feb. 12, 2021

(30) Foreign Application Priority Data
Aug. 22, 2018 (JP) 2018-155747

(51) Int. Cl. G06E 1/04

(52) U.S. Cl. CPC G06E 1/04

(57) ABSTRACT

An optical signal processing device capable of performing computation without changing a device configuration even when the number of input and output dimensions changes is provided. An optical signal processing device for converting an input M (M is an integer equal to or greater than 2)-dimensional input signal to an optical signal to perform signal processing includes an input unit configured to convert the input M-dimensional input signal to a one-dimensional input signal, and perform linear processing on the one-dimensional input signal to convert the one-dimensional input signal to an optical signal, a reservoir unit connected to an output of the input unit and configured to perform linear processing and nonlinear processing on the optical signal, and an output unit connected to an output of the reservoir unit and configured to convert the optical signal to an electrical signal to perform linear processing, and output an N-dimensional output.

### TECHNICAL FIELD

The present invention relates to an optical signal processing device that can be applied to optical reservoir computing.

### BACKGROUND ART

In recent years, an environment has been constructed to acquire a large amount of data from various sensors via the Internet, and research and business for analyzing the large amount of acquired data and performing highly accurate knowledge processing and future prediction have been actively carried out. In general, because analysis of a large amount of data requires time and incurs costs such as power consumption, computing devices having high speed and high efficiency are required. As a computing scheme for such information processing, an optical computing technique called reservoir computing (RC), which imitates signal processing of the cerebellum, has been proposed. Optical computing devices using a dynamical system are attracting attention because such devices are likely to have both high speed and high efficiency.

In examples of applications of optical RC in the related art, examples of solving a one-dimensional input and output problem such as a chaos approximation problem and NARMA 10 have mainly been reported (for example, see Non Patent literature 1). Further, in order to meet recent demands for data analysis, it will be necessary to extend the application range of optical RC, and there is a demand for the extension of the input and output problem to multiple dimensions. However, when a method taken in a one-dimensional input problem is simply developed, the number of modulators and demodulators that modulate and demodulate input and output data monotonically increases with an increase in the number of dimensions. Thus, with an increase in the number of input and output dimensions, a complicated and large-scale computation device is required.

### CITATION LIST

### Non Patent Literature

Non Patent Literature 1: L. Larger, et al., “Photonic information processing beyond Turing: an optoelectronic implementation of reservoir computing,” Optics Express Vol. 20, Issue 3, pp. 3241-3249 (2012)

### SUMMARY OF THE INVENTION

### Technical Problem

In optical RC of the related art, because the number of modulators and demodulators increases with an increase in the number of dimensions of input and output, a computation device becomes complicated and large-scaled, and thus, there is a problem that the manufacturing cost of the device increases.

### Means for Solving the Problem

An object of the present invention is to provide an optical signal processing device capable of performing computation without changing a device configuration even when the number of input and output dimensions changes.

In order to achieve such an object, an aspect of the present invention is an optical signal processing device for converting an input M (M is an integer equal to or greater than 2)-dimensional input signal to an optical signal to perform signal processing, the optical signal processing device including: an input unit configured to convert the input M-dimensional input signal to a one-dimensional input signal, and perform linear processing on the one-dimensional input signal to convert the one-dimensional input signal to an optical signal; a reservoir unit connected to an output of the input unit and configured to perform linear processing and nonlinear processing on the optical signal; and an output unit connected to an output of the reservoir unit and configured to convert the optical signal to an electrical signal to perform linear processing to output an N-dimensional output.

### Effects of the Invention

As described above, according to the present invention, by compressing an M-dimensional input signal into a one-dimensional input signal in the input unit, it is possible to perform computation without changing a device configuration even when the number of input and output dimensions changes.

### BRIEF DESCRIPTION OF DRAWINGS

FIG. 1 is a diagram illustrating an overall configuration of an optical signal processing device according to an embodiment of the present invention.

FIG. 2 is a diagram illustrating a configuration of an input unit of the optical signal processing device according to the embodiment.

FIG. 3 is a diagram illustrating a conversion operation in the input unit.

FIG. 4 is a diagram illustrating a specific example of data compression in the input unit.

FIG. 5 is a diagram illustrating a configuration of a reservoir unit of the optical signal processing device according to the embodiment.

FIG. 6 is a diagram illustrating a specific operation example of the reservoir unit.

FIG. 7 is a diagram illustrating a first example of a connection form of the input unit and the reservoir unit.

FIG. 8 is a diagram illustrating a second example of the connection form of the input unit and the reservoir unit.

FIG. 9 is a diagram illustrating a configuration of an output unit of the optical signal processing device according to the embodiment.

FIG. 10 is a diagram illustrating a modification example of the output unit of the optical signal processing device according to the embodiment.

### DESCRIPTION OF EMBODIMENTS

Hereinafter, an embodiment of the present invention will be described in detail with reference to the drawings.

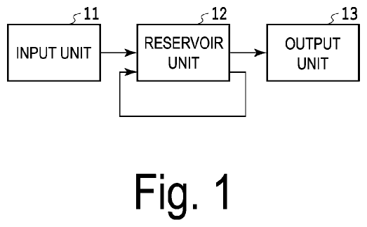

FIG. 1 illustrates an overall configuration of an optical signal processing device according to an embodiment of the present invention. The optical signal processing device includes an input unit 11 configured to convert an input M (M is an integer equal to or greater than 2)-dimensional input signal to a one-dimensional input signal to convert the one-dimensional input signal to an optical signal, and a reservoir unit 12 connected to an output of the input unit 11 and configured to perform a random combination computation process on the optical signal, and an output unit 13 connected to an output of the reservoir unit 12 and configured to convert the optical signal to an electrical signal to perform linear processing to output an N-dimensional output.

The optical signal processing device of the embodiment compresses M-dimensional data into one-dimensional data in the input unit, and thus, it is possible to perform computation using the same device configuration even when input and output of different numbers of dimensions are required.

Input Unit

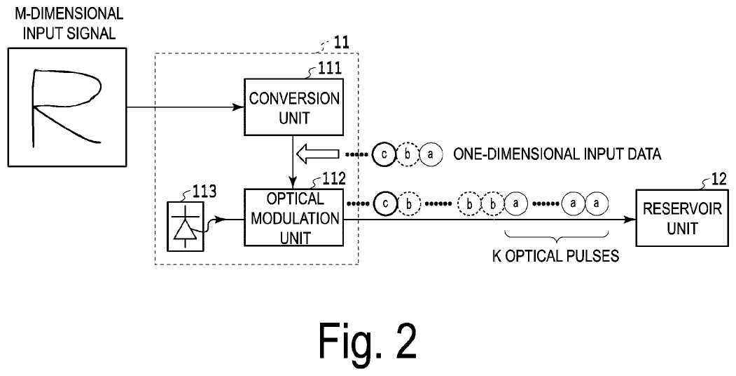

FIG. 2 illustrates a configuration of the input unit of the optical signal processing device according to the embodiment. The input unit 11 has a function of receiving an M-dimensional input signal of a problem to be solved, and converting the M-dimensional input signal to a predetermined optical signal (an optical pulse train) to propagate the optical signal to the reservoir unit 12. The input unit 11 includes a conversion unit 111 that converts an input M-dimensional input signal to a one-dimensional input signal, and an optical modulation unit 112 that extends the one-dimensional input signal in a time axis direction and performs linear processing to modulate an optical signal from the light source 113 and generate an optical pulse train.

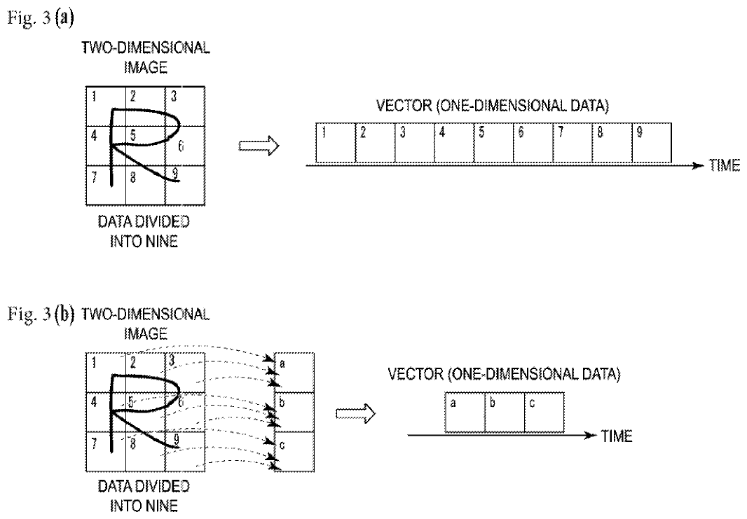

A conversion operation in the input unit will be described with reference to FIG. 3. Description will be given with a two-dimensional image signal as an example of the M-dimensional input signal that is input to the conversion unit 111. The two-dimensional image signal is vertically and horizontally divided in three so that 3×3=9 pieces of pixel data are obtained, and the pixel data is read row by row and converted to one-dimensional data, as illustrated in FIG. 3(a). When the one-dimensional data is serially output, a vector consisting of nine pieces of pixel data is generated, a vector length becomes long, and a calculation time is increased. Thus, each row is compressed into one piece of data and converted to one-dimensional data, and an arbitrarily weighted one-dimensional input signal is output, as illustrated in FIG. 3(b).

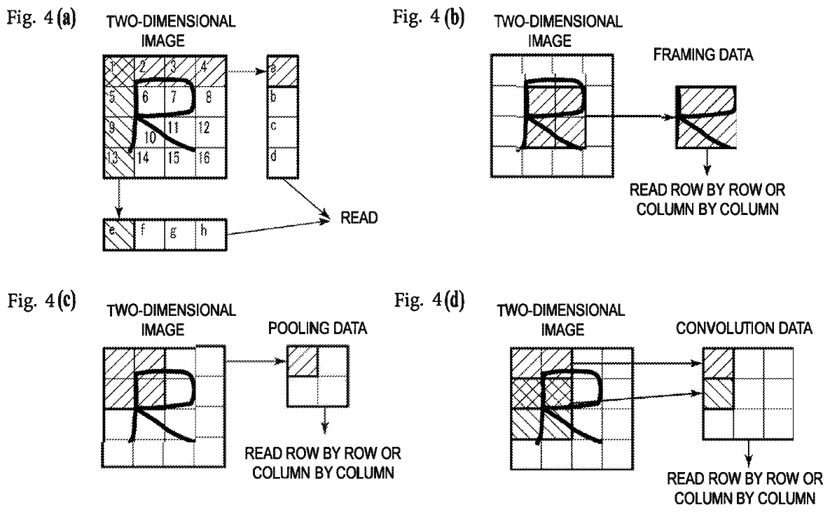

FIG. 4 illustrates a specific example of data compression in the input unit. In the example of FIG. 4(a), pixel data of the two-dimensional image signal is compressed into one piece of data row by row or column by column, read row by row or column by column, and converted to one-dimensional data. FIG. 4(b) illustrates a framing method, in which data obtained by cutting an outer frame for any pixels is read row by row or column by column and converted to one-dimensional data. FIG. 4(c) illustrates a pooling method, in which an M-dimensional input signal is equally divided into squares having any size. Divided pooling data is compressed into one piece of data, read row by row or column by column, and converted to one-dimensional data. FIG. 4(d) illustrates a convolution method, in which pixels included in a reading window having any size are compressed into one piece of data to generate convolution data, which is read row by row or column by column and converted to one-dimensional data.

Examples of weighting at the time of compression of data include a method of multiplying randomly determined weights, an averaging method, a method of extracting a maximum value, and a method of extracting a minimum value.

A case in which the input signal is distributed from 1 input channel to m nodes of the reservoir layer in normal RC is considered. Here, the input channel refers to the number of elements included in the one-dimensional input signal, and is a number corresponding to the number of pixels included in the one-dimensional input signal when an input signal is pixel data. The optical modulation unit 112 generates a time-series signal obtained by extending the one-dimensional input signal K-fold in the time axis direction for each input channel. For example, when one input channel is one second, a pulse having a pulse width of K seconds is generated. A subscript K is 1<K<=m, and is intended to cause K nodes to be selected from among m nodes of normal RC and cause a one-dimensional input signal to be input.

A randomly determined weight wⁱⁿₗₘ of the input unit is then multiplied with the extended time-series signal. A subscript 1 is a type of the one-dimensional signal in the first layer corresponding to pixel data for one row of the two-dimensional image signal, and is N in the second and subsequent layers. This allows a pulse extended to K seconds to be a modulation signal having a different intensity for one second. The optical modulation unit 112 modulates the optical signal from the light source 113 with a modulation signal having information of wⁱⁿₗₘ·uₘ.

Thus, the input unit 11 outputs, to the reservoir unit 12, a pulse train in which K pulses having a light intensity corresponding to a magnitude (intensity) of the input signal are connected by the number of rows or columns of the two-dimensional image signal for each input channel.

For the light source 113, an incoherent light source or a coherent light source can be used. When the former is used, the light source can be operated relatively stably because only intensity information is used. When the latter is used, an amount of information can be doubled because both intensity information and phase information are used.

For the optical modulation unit 112, an optical attenuator such as an LN modulator or an optical amplifier such as a semiconductor optical amplifier can be used. When the former is used, it is possible to shorten a computing time because modulation can be performed at a high speed. When the latter is used, it is possible to curb deterioration of computing capability due to a loss because a signal can be amplified.

A weight wⁱⁿ of the input unit is given before training of optical RC starts, and a value of the weight is not updated through training or a determination. All values of respective elements of the weight wⁱⁿ (weight wⁱⁿ=>0) may be different values, or may be the same value for the same m. Although the number of weights differs between the first layer and the second layer, the weights may be different or some of the weights may be the same.

Reservoir Unit

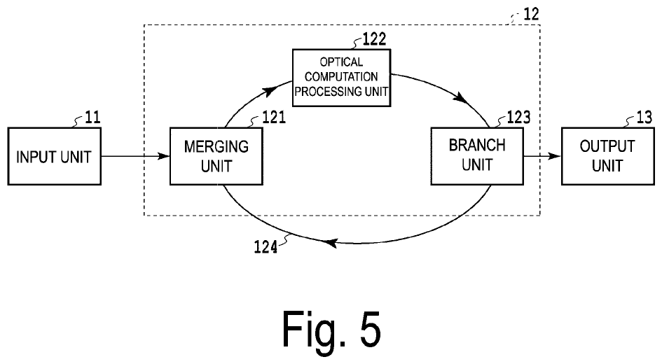

FIG. 5 illustrates a configuration of the reservoir unit of the optical signal processing device according to the embodiment. In the reservoir unit 12, a merging unit 121, an optical computation processing unit 122, and a branch unit 123 are provided on a ring waveguide 124 around which an optical pulse train circulates. Going from the merging unit 121 to the ring waveguide 124 and back to the merging unit 121 is counted as one round. After a first pulse train is input to the ring waveguide 124, a one-dimensional input signal propagating from the input unit 11 at a t-th round and a one-dimensional input signal circulating around the ring waveguide 124 and returning to the merging unit 121 at a (t−1)-th round are combined by the merging unit 121. The optical computation processing unit 122 performs computation processing on the combined one-dimensional input signal, and the branch unit 123 causes the processed one-dimensional input signal (optical pulse train) to branch to output the branching one-dimensional input signal to the output unit 13 and the merging unit 121.

A dynamic system in the reservoir unit 12 is shown in Equation (1).

Math. 1

xₗ(t)=cos²(Σₘ^{K}wₗₘⁱⁿ·uₘ(t)+Σk^{K}wₗₖ^{r}·xₖ(t−1)) (1)

Here, uₘ is an input channel of the input unit 11 and corresponds to a node of the input layer, wⁱⁿₗₘ corresponds to a weight of the input unit, xₖ(t−1) corresponds to a node of the reservoir layer when a pulse circulates around the waveguide 124 t−1 times, w^{r}ₗₖ represents a weight of the reservoir unit, and xi corresponds to m nodes of the reservoir layer. Among components input to a cos square function of Equation (1), a first term indicates a signal coupled from the input unit 11, and a second term indicates a signal coupled from the reservoir unit 12. A weight w^{r} of the reservoir unit is a fixed value that is randomly determined, like the weight of the input unit. The optical computation processing unit 122 performs linear processing for multiplying the weight w^{r} of the reservoir unit and nonlinear processing for performing computation of a nonlinear function (a cos square function). The weight w^{r} of the reservoir unit is a fixed value that is randomly determined, as in the input unit.

For the optical computation processing unit 122, methods of performing linear processing include a method of using an LN modulator and a delay circuit, and a method of demodulating a signal with an electrical signal temporarily, performing electrical computation processing using a PC, an FPGA, or the like, and then performing restoration of an optical signal. When the former is used, a processing speed becomes higher because the computation is performed at the speed of light. When the latter is used, it is possible to ensure computing accuracy because signal compensation can be performed when conversion to electricity is performed.

The optical computation processing unit 122 can use, for example, a Mach-Zehnder interferometer or a semiconductor optical amplifier in order to perform the nonlinear processing. When the former is used, power consumption is reduced because nonlinear processing is performed with only passage through the Mach-Zehnder interferometer without using a control signal. When the latter is used, it is possible to change a form of the nonlinear function from the cos square function by changing a current value input to the semiconductor optical amplifier, and to perform adjustment to an appropriate nonlinear function for a problem to be solved.

For the merging unit 123, for example, a planar optical waveguide (PLC) or a fusion-extended fiber coupler can be used. When the former is used, it is possible to reduce a connection loss and construct a device with a low loss. When the latter is used, it is possible to easily construct the device by combining commercially available products.

Specific Operation Example

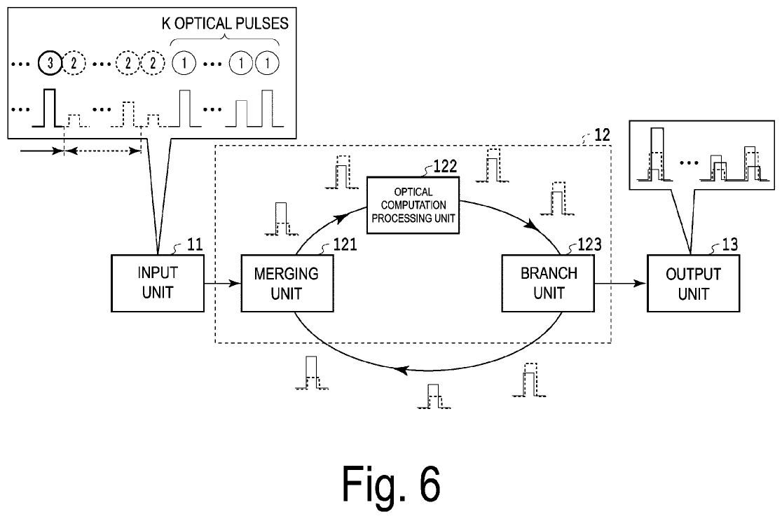

A specific operation example of the reservoir unit when K=m will be described with reference to FIG. 6. The ring waveguide 124 of the reservoir unit 12 is set to have a length in which m pulses circulate once at equal intervals. When pulse trains are input sequentially from K (=m) pulse trains of a first type from the input unit 11, the pulse trains sequentially circulate around the ring waveguide 124, and when K (=m) pulses of a 9-th type are input, all nine types of pulses are caused to overlap, as illustrated in FIG. 6. In the optical computation processing unit 122, the linear processing for multiplying the weight w^{r} of the reservoir unit and the nonlinear processing for passing a cos square function are performed for each circulation of the pulse, and adjustment of light intensity of the pulse that is an appropriate fixed value is performed. K pulses, each including nine overlapping pulses, are output from the branch unit 123 to the output unit 13.

The ring waveguide 124 may be extended in length so that K (=m) or more pulses can circulate at the same time in consideration of extensibility. In this case, in the pulse train output from the input unit 11, an idle period of time corresponding to the extended length is inserted into every K pulses. Thus, the two-dimensional image signal divided in nine is processed by the m nodes of the reservoir layer.

Connection Form of Input Unit and Reservoir Unit

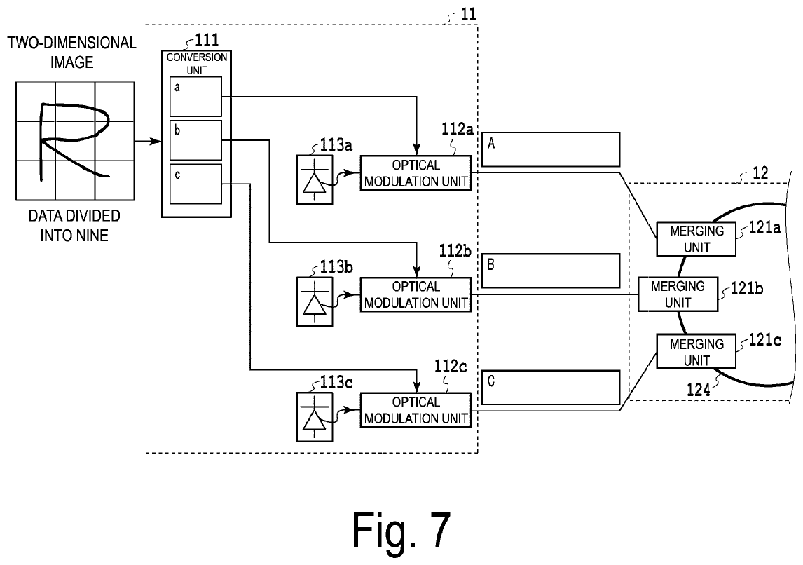

FIG. 7 illustrates a first example of a connection form of the input unit and the reservoir unit. In the configuration illustrated in FIG. 2, the input unit 11 compresses the two-dimensional image signal into one piece of data for each row, converts the data to three pieces of one-dimensional data, extends each of pieces of the one-dimensional data K-fold in a time axis direction to generate a time-series signal, and serially transmits the time-series signals to the reservoir unit 12 in order. On the other hand, a plurality (three sets in the first example) of the optical modulation units 112 and the light sources 113 of the input unit 11 and the merging units 121 of the reservoir unit 12 may be prepared, and parallel transmission may be performed between the input unit 11 and the reservoir unit 12.

The merging units 121a to 121c of the reservoir unit 12 adjust a timing so that the one-dimensional input signals propagating from the input unit 11 overlap on the ring waveguide 124, and output the one-dimensional input signals. Although the device configuration is complicated, the number of circulations is decreased due to the optical pulse trains being caused to overlap in the reservoir unit 12, and thus, it is possible to perform computation at a higher speed.

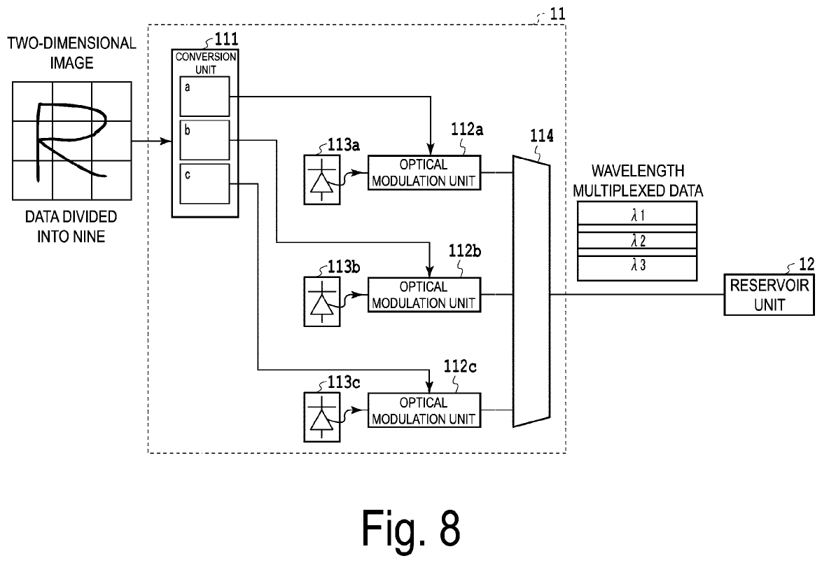

FIG. 8 illustrates a second example of the connection form between the input unit and the reservoir unit. In the second example, a plurality (three sets in the second example) of the optical modulation units 112 and the light sources 113 of the input unit 11 are prepared, wavelengths of the light sources 131a to 131c are changed, and the one-dimensional input signals of the respective sets are generated as optical pulse trains having different wavelengths. A multiplexing unit 114 multiplexes the optical pulse trains of the respective sets to generate the one-dimensional input signal and transmits the one-dimensional input signal to the reservoir unit 12.

It is not necessary for the configuration of the reservoir unit 12 to be changed, and it is possible to simplify a device configuration, unlike the first example.

Output Unit

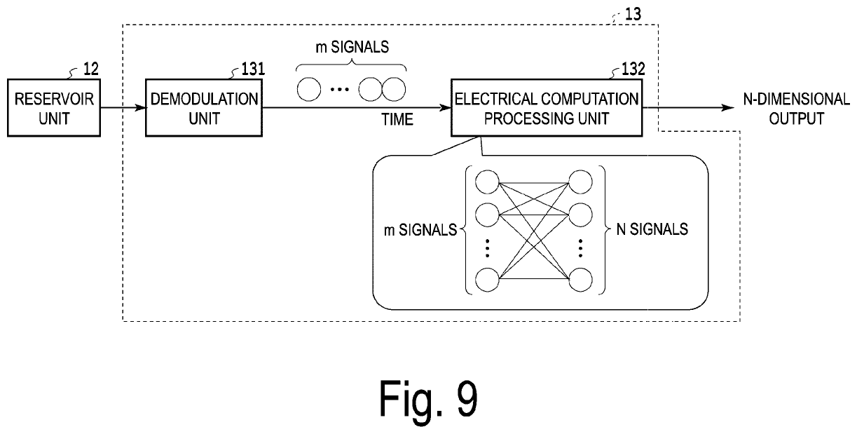

FIG. 9 illustrates a configuration of the output unit of the optical signal processing device according to the embodiment. The output unit 13 processes the optical pulse train emitted from the reservoir unit 12 to generate an N-dimensional output. The output unit 13 includes a demodulation unit 131 that converts the optical pulse train emitted from the reservoir unit 12 to an electrical signal, and an electrical computation processing unit 132 that extracts m one-dimensional signals at a time from the converted electrical signal to perform linear processing of m input N output.

A dynamic system in the output unit 13 is shown in Equation (2).

Math. 2

yⱼ(t)=Σₖ^{m}wⱼₖ⁰·xₖ(t) (2)

Here, yⱼ corresponds to a node of the output layer, and w⁰ⱼₖ is a weight of the output unit. The electrical computation processing unit 132 extracts m of the one-dimensional signals xₖ(t) output from the demodulation unit at a time to compute linear combination shown in Equation (2). The computation is repeated a number of times corresponding to the number N of categories to be classified, and an N-dimensional output is generated from the m signals. A weight w⁰ of the output unit is a value that is calculated by a pseudo-inverse matrix method using a node xₖ(t) of the reservoir unit 12 and a desired result of the problem to be solved. This value is different for each layer.

For the demodulation unit 131, a light receiver is used. For the electrical computation processing unit 132, a PC and an FPGA, for example, can be used. When the former is used, it is possible to implement a dynamical system relatively easily. When the latter is used, it is possible to increase a computing speed because a dedicated machine can be manufactured.

Modification Example of Output Unit

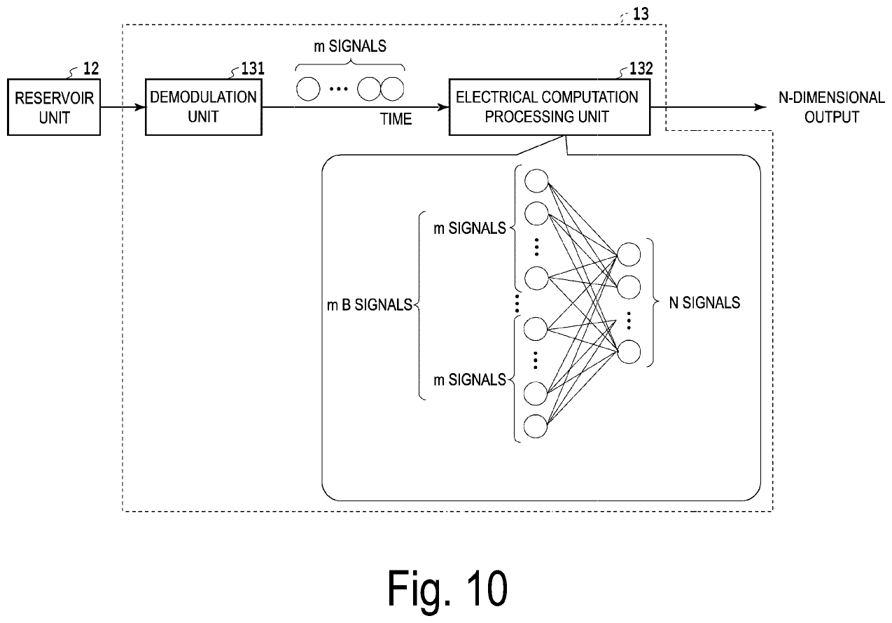

FIG. 10 illustrates a modification example of the output unit of the optical signal processing device according to the embodiment. Because a basic configuration is the same as that in FIG. 8, only different portions will be described. The output unit 13 processes the optical pulse train emitted from the reservoir unit 12 to generate an N-dimensional output. The output unit 13 includes a demodulation unit 131 that converts the optical pulse train emitted from the reservoir unit 12 to an electrical signal, and an electrical computation processing unit 132 that extracts m B one-dimensional signals at a time from the converted electrical signal to perform linear processing of m B input N output.

The electrical computation processing unit 132 extracts m B one-dimensional signals xₖ(t) output from the demodulation unit at a time to compute the linear combination shown in Equation (2). The computation is repeated a number of times corresponding to the number N of categories to be classified, and an N-dimensional output is generated from the m B signals. This B is the number of circulations of the reservoir unit 12, and m B signals emitted while the pulse train circulates around the reservoir unit 12 B times are input to the electrical computation processing unit 132. A weight w° of the output unit is a value that is calculated by a pseudo-inverse matrix method using the m×B signals obtained from the reservoir unit 12 and a desired classification result of input data.

For example, considering a case in which data of 3×3 pixels is input row by row as illustrated in FIG. 3, a classification result is output from the output unit 13 each time data of one row is input. In order to obtain all classification results, it is necessary for each of probabilities of classification results for three rows to be calculated again. According to the embodiment, when B=3, a classification result for one sheet can be calculated by only one calculation of the output unit 13, and thus, there is an advantage that recalculation is unnecessary.

With the optical signal processing device of the embodiment, it is possible to perform computation using the same device configuration even when input and output of different numbers of dimensions are required. Because it is not necessary for the number of modulators and demodulators to be increased even when the number of input and output dimensions increases, it is possible to curb an increase in manufacturing cost of the device, unlike optical RC of the related art.

### REFERENCE SIGNS LIST

11 Input unit
12 Reservoir unit
13 Output unit
111 Conversion unit
112 Optical modulation unit
113 Light source
114 Multiplexing unit
121 Merging unit
122 Optical computation processing unit
123 Branch unit
124 Ring waveguide
131 Demodulation unit
132 Electrical computation processing unit

1. An optical signal processing device for converting an input M (M is an integer equal to or greater than 2)-dimensional input signal to an optical signal to perform signal processing, the optical signal processing device comprising:
an input unit configured to convert the input M-dimensional input signal to a one-dimensional input signal, and perform linear processing on the one-dimensional input signal to convert the one-dimensional input signal to an optical signal;
a reservoir unit connected to an output of the input unit and configured to perform linear processing and nonlinear processing on the optical signal; and
an output unit connected to an output of the reservoir unit and configured to convert the optical signal to an electrical signal to perform linear processing to output an N-dimensional output.

2. The optical signal processing device according to claim 1, wherein the input unit includes:
a light source;
a conversion unit configured to compress the input M-dimensional input signal to a one-dimensional signal, and multiply a predetermined weight with the one-dimensional signal to convert the one-dimensional signal to the one-dimensional input signal; and
an optical modulation unit connected to the light source and configured to extend the one-dimensional input signal from the conversion unit in a time axis direction, perform linear processing to generate a modulation signal, and generate an optical pulse train using the modulation signal.

3. The optical signal processing device according to claim 1, wherein the input unit includes:
a plurality of light sources with different wavelengths;
a conversion unit configured to compress the input M-dimensional input signal to a plurality of one-dimensional signals, and multiply a predetermined weight with the one-dimensional signals to convert the one-dimensional signals to a plurality of one-dimensional input signals;
a plurality of optical modulation units, each of the plurality of optical modulation units configured to extend one of the plurality of one-dimensional input signals from the conversion unit in a time axis direction, perform linear processing to generate a modulation signal, and modulate an output from one of the plurality of light sources using the modulation signal to generate one of optical pulse trains; and
a multiplexing unit configured to multiplex the plurality of modulated optical pulse trains from the plurality of optical modulation units.

4. The optical signal processing device according to claim 2, wherein the reservoir unit includes:
a merging unit configured to input the optical pulse train from the input unit to a ring waveguide;
an optical computation processing unit configured to perform linear processing and nonlinear processing on the optical pulse train that circulates around the ring waveguide; and
a branch unit configured to cause the optical pulse train processed in the optical computation processing unit to branch to output the branching optical pulse train to the output unit and the merging unit.

5. The optical signal processing device according to claim 2, wherein the input unit includes:
a conversion unit configured to compress the input M-dimensional input signal to a plurality of one-dimensional signals, and multiply a predetermined weight with the one-dimensional signals to convert the one-dimensional signals to a plurality of one-dimensional input signals; and
a plurality of optical modulation units, each of the plurality of optical modulation unit configured to extend one of the plurality of one-dimensional input signals from the conversion unit in a time axis direction, perform linear processing to generate a modulation signal, and modulate an optical signal from the light source using the modulation signal to generate one of optical pulse trains, and
the reservoir unit includes:
a plurality of merging units, each of the plurality of merging units configured to input each of the optical pulse trains from the plurality of optical modulation units to a ring waveguide;
an optical computation processing unit configured to perform linear processing and nonlinear processing on the optical pulse train that circulates around the ring waveguide; and
a branch unit configured to cause the optical pulse train processed in the optical computation processing unit to branch to output the branching optical pulse train to the output unit and the merging unit.

6. The optical signal processing device according to claim 1, wherein the output unit includes:
a demodulation unit configured to convert the optical pulse train processed in the reservoir unit to an electrical signal; and
an electrical computation processing unit configured to extract m one-dimensional signals at a time from the electrical signal to perform linear processing, and output an N-dimensional output.

7. The optical signal processing device according to claim 1, wherein the output unit includes:
a demodulation unit configured to convert the optical pulse train processed in the reservoir unit to an electrical signal; and
an electrical computation processing unit configured to extract m×B (B is an integer equal to or greater than 2) one-dimensional signals at a time from the electrical signal to perform linear processing, and output an N-dimensional output.

8. An optical signal processing device that converts an input M (M is an integer equal to or greater than 2)-dimensional signal to an optical signal to perform signal processing, and outputs an N-dimensional output, the optical signal processing device comprising:
an input unit configured to compress the input M-dimensional input signal into a one-dimensional signal, multiply a predetermined weight with the one-dimensional signal to convert the one-dimensional signal to a one-dimensional input signal, extend the one-dimensional input signal K (1<=K<=m)-fold in a time axis direction, and multiply a predetermined weight with the extended one-dimensional input signal to convert the multiplied one-dimensional input signal to K optical pulse trains;
a reservoir unit configured to cause the optical pulse trains from the input unit to circulate around a ring waveguide so that the optical pulse trains overlap, multiply a predetermined weight with the overlapped optical pulse train, and perform computation of a nonlinear function; and
an output unit configured to convert the optical pulse train processed in the reservoir unit to an electrical signal, and extract m one-dimensional signals from the converted electrical signal at a time to multiply a predetermined weight with the one-dimensional signals to generate an N-dimensional output.

9. An optical signal processing device that converts an input M (M is an integer equal to or greater than 2)-dimensional signal to an optical signal to perform signal processing, and outputs an N-dimensional output, the optical signal processing device comprising:
an input unit configured to compress the input M-dimensional input signal into a one-dimensional signal, multiply a predetermined weight with the one-dimensional signal to convert the one-dimensional signal to a one-dimensional input signal, extend the one-dimensional input signal K (1<=K<=m)-fold in a time axis direction, and multiply a predetermined weight with the extended one-dimensional input signal to convert the multiplied one-dimensional input signal to K optical pulse trains;
a reservoir unit configured to cause the optical pulse trains from the input unit to circulate around a ring waveguide so that the optical pulse trains overlap, multiply a predetermined weight with the overlapped optical pulse train, and perform computation of a nonlinear function; and
an output unit configured to convert the optical pulse train processed in the reservoir unit to an electrical signal, and extract m×B (B is an integer equal to or greater than 2) one-dimensional signals from the converted electrical signal at a time to multiply a predetermined weight with the one-dimensional signals to generate an N-dimensional output.
